(19) United States
(12) Patent Application Publication
(10) Pub. No.: US 2013/0148637 A1
(43) Pub. Date: Jun. 13, 2013

(54) DEVICE-TO-DEVICE COMMUNICATION CONTROL METHOD

(71) Applicant: Electronics and Telecommmunications Research I, Daejeon (KR)

(72) Inventors: Mi Jeong YANG, Daejeon (KR); Soon Yong LIM, Daejeon (KR); Ae Soon PARK, Daejeon (KR)

(73) Assignee: Electronics and Telecommmunications Research Institute, Daejeon (KR)

(21) Appl. No.: 13/707,045

(22) Filed: Dec. 6, 2012

(30) Foreign Application Priority Data
Dec. 9, 2011 (KR) 10-2011-0131669

(51) Int. Cl. H04W 72/04

(52) U.S. Cl. CPC H04W 72/042; H04W 72/044
USPC 370/336; 370/329

(57) ABSTRACT

Provided is a device-to-device (D2D) communication control method. A D2D communication control method performed in a control apparatus includes allocating resources for D2D communication, and including information about the allocated resources in D2D-downlink control information (DCI) and transmitting the D2D-DCI to terminals that will perform D2D communication. Accordingly, it is possible to efficiently allocate radio resources for D2D communication, and reduce the load of self-control of terminals.

### CLAIM FOR PRIORITY

This application claims priority to Korean Patent Application No. 10-2011-0131669 filed on Dec. 9, 2011 in the Korean Intellectual Property Office (KIPO), the entire contents of which are hereby incorporated by reference.

### BACKGROUND

1. Technical Field

Example embodiments of the present invention relate in general to device-to-device (D2D) communication, and more particularly, to a D2D communication control method for efficiently allocating resources for D2D communication and controlling D2D communication.

2. Related Art

Recently, with the proliferation of various smart terminal devices, data traffic has remarkably increased, and significant problems have occurred in network capacity, data transmission rates, service quality, and so on. As a method for solving these problems, D2D communication is considered in a next-generation mobile communication system such as Third Generation Partnership Project (3GPP) Long Term Evolution (LTE) (-Advanced).

In a cellular mobile communication system, D2D communication denotes a communication method of performing direct data transmission and reception between two adjacent terminals via no base station. In other words, two adjacent terminals set a D2D communication link using resources for cellular mobile communication, and then perform communication using the D2D communication link via no base station.

In related art, mobile communication terminals that want to communicate with each other should perform communication via a mobile communication base station although the mobile communication terminals are geographically adjacent to each other. On the other hand, D2D communication allows direct data exchange between terminals, and thus can improve the transmission rates of terminals present at cell boundaries with no increase in infrastructure cost, support cellular network access of terminals present in a shadow region, and lead to an increase in system capacity through interference reduction.

Due to merits such as extended cell coverage, improved security, etc. compared to existing wireless fidelity (Wi-Fi) Direct, Bluetooth, and Zigbee technology, the importance of D2D communication technology is being magnified, and also 3GPP is moving to implement standardization.

Meanwhile, to support D2D communication in a cellular mobile communication system, resources for cellular mobile communication should be used in D2D communication. Thus, there is a necessity for a method for efficiently allocating cellular mobile communication resources to D2D communication and controlling D2D communication.

As the simplest resource allocation method for D2D communication, there is a method of allocating some of resources used for cellular communication as exclusive D2D communication resources. However, such a resource allocation method may cause as large a reduction in cellular communication resources as resources allocated to D2D communication, and may cause a reduction in profit of a communication service provider, and an increase in communication service charge of a user when a sufficient business model is not provided to D2D communication due to the reason.

### SUMMARY

Accordingly, example embodiments of the present invention are provided to substantially obviate one or more problems due to limitations and disadvantages of the related art.

Example embodiments of the present invention provide a device-to-device (D2D) communication control method capable of efficiently allocating resources for D2D communication, and controlling a plurality of terminals to perform D2D communication using the allocated resources.

In some example embodiments, a D2D communication control method performed in a control apparatus includes: allocating resources for D2D communication; and including information about the allocated resources in D2D-downlink control information (DCI), and transmitting the D2D-DCI to terminals that will perform D2D communication.

Here, allocating the resources for D2D communication may include allocating one kind of resources among uplink and downlink resources of a cellular mobile communication system, and setting information for distinguishing a transmission terminal and a reception terminal between the terminals that will perform D2D communication and at least one piece of control information among transmission power, a modulation and coding scheme (MCS), and bundling time information indicating a time for performing D2D communication.

Here, allocating the resources for D2D communication may include allocating, at the control apparatus, the resources for D2D communication in consideration of a condition of resources used in cellular communication, and interference between terminals performing cellular communication and the terminals that will perform D2D communication.

Here, the D2D communication control method may further include: allocating D2D-radio network temporary identifiers (RNTIs) for addressing the D2D terminals that will perform D2D communication; and including the D2D-RNTIs in a radio resource control (RRC) connection reconfiguration message, and transmitting the RRC connection reconfiguration message to the D2D terminals.

Here, allocating the D2D-RNTIs may include, when the terminals belong to the same communication group in a predetermined D2D communication service type, allocating the same D2D-RNTI to the terminals.

In other example embodiments, a D2D communication control method includes: acquiring information about resources allocated for D2D communication on the basis of received DCI; when the allocated resources are uplink resources, and it is not possible to receive transmitted data through uplink resources in a current reception mode, switching the reception mode from a first reception mode to a second reception mode; receiving D2D communication data in the second reception mode; and when reception of the D2D communication data is finished, switching the reception mode from the second reception mode to the first reception mode.

Here, switching the reception mode from the first reception mode to the second reception mode may be performed in a transmission time interval (TTI) ahead of a TTI in which reception of the D2D communication data is started on the basis of the DCI.

Here, receiving the D2D communication data in the second reception mode may include receiving the data during a D2D bundling time included in the DCI, and switching the reception mode from the second reception mode to the first reception mode may be performed after the D2D bundling time expires.

In other example embodiments, a D2D communication control method includes: acquiring information about resources allocated for D2D communication on the basis of received DCI; when the allocated resources are downlink resources, and it is not possible to transmit data through downlink resources in a current transmission mode, switching the transmission mode from a first transmission mode to a second transmission mode; transmitting D2D communication data in the second transmission mode; and when transmission of the D2D communication data is finished, switching the transmission mode from the second transmission mode to the first transmission mode.

Here, switching the transmission mode from the first transmission mode to the second transmission mode may be performed in a TTI ahead of a TTI in which transmission of D2D communication is started on the basis of the DCI.

Here, transmitting the data in the second transmission mode may include transmitting the data during a D2D bundling time included in the DCI, and switching the transmission mode from the second transmission mode to the first transmission mode may be performed after the D2D bundling time expires.

In other example embodiments, a D2D communication control method includes: allocating, at a control apparatus, resources for D2D communication; including, at the control apparatus, allocation information about the allocated resources in D2D-DCI, and transmitting the D2D-DCI to D2D terminals that will perform D2D communication; acquiring, at each of the D2D terminals, the resource allocation information on the basis of the received DCI; switching, at each of the D2D terminals, a transmission or reception mode on the basis of the resource allocation information; performing, at the D2D terminals, D2D communication; and switching, at each of the D2D terminals, the post-switching transmission or reception mode back to the original mode after D2D communication is finished.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of a network environment to which a device-to-device (D2D) communication control method according to an example embodiment of the present invention is applied;

FIG. 2 is a flowchart illustrating a D2D communication control method according to an example embodiment of the present invention;

FIG. 3 is a flowchart illustrating a D2D communication control method according to another example embodiment of the present invention;

FIG. 4 is a conceptual diagram illustrating D2D-radio network temporary identifiers (RNTIs) allocated to terminals that will perform D2D communication in a D2D communication control method according to an example embodiment of the present invention; and

FIG. 5 is a flowchart illustrating a procedure of allocating D2D-RNTIs in a D2D communication control method according to an example embodiment of the present invention.

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, example embodiments of the present invention will be described in detail with reference to the appended drawings. To aid in understanding the present invention, like numbers refer to like elements throughout the description of the figures, and the description of the same component will not be reiterated.

The term “terminal” used herein may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), mobile node, mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or devices having a combination of such functions, but are not limited to these.

The term “base station” used herein generally denotes a fixed or moving point that communicates with a terminal, and may be a common name for Node-B, evolved Node-B (eNode-B), base transceiver system (BTS), access point, relay, femto-cell, and so on.

In a Third Generation Partnership Project (3GPP)-based cellular mobile communication system, a base station controls data communication of terminals. In other words, a base station transmits downlink control information (DCI) including resource allocation information, control information, etc. for communication of a terminal to the terminal through a physical downlink control channel (PDCCH), and the terminal uses allocated resources and adjusts transmission power on the basis of the DCI received from the base station, thereby performing communication.

Specifically, DCI used in a cellular mobile communication system includes downlink scheduling allocation information, uplink scheduling allocation information, power control information about a physical uplink channel, power control information about a physical downlink channel, etc., and has a varying size according to included information.

In a D2D communication control method according to an example embodiment of the present invention, D2D-DCI is defined to control D2D communication of a terminal.

D2D-DCI may include resource allocation information and control information for D2D communication. Here, the resource allocation information may include link (i.e., uplink or downlink) configuration information to be used for D2D communication, resource allocation information to be used for data transmission in a configured uplink or downlink (e.g., resource block allocation information about a PDSCH or physical uplink shared channel (PUSCH)), and D2D bundling time denoting D2D communication time.

The control information included in D2D-DCI may include a modulation and coding scheme (MCS), transmission power information, and so on. Also, the control information may include terminal identification information for distinguishing a transmission terminal and a reception terminal between terminals that will perform D2D communication.

In an existing 3GPP-based cellular mobile communication system, a base station uses an orthogonal frequency division multiple access (OFDMA) transmission technique to transmit data through a downlink, and a terminal receives the data that is transmitted from the base station using the OFDMA transmission technique. Also, the terminal uses a single-carrier frequency division multiple access (SC-FDMA) technique to transmit data through an uplink.

Thus, an existing 3GPP-based terminal only has an SC-FDMA transmission function for an uplink, and an OFDMA reception function for a downlink.

However, when uplink resources are used in D2D communication, a reception terminal between terminals performing the D2D communication should support a function of receiving data transmitted using SC-FDMA technology, and switch an operation mode of a receiver prepared in the terminal to the SC-FDMA reception function during D2D communication.

Also, when downlink resources are used in D2D communication, a transmission terminal between terminals performing D2D communication should transmit data using OFDMA technology, and switch an operation mode of a transmitter prepared in the terminal to an OFDMA transmission function during D2D communication.

In example embodiments of the present invention, it is assumed that a transmitter prepared in each terminal performing D2D communication has a first transmission mode and a second transmission mode, and can switch between the first and second transmission modes according to resources allocated to D2D communication, and a receiver prepared in each terminal performing D2D communication has a first reception mode and a second reception mode, and can switch between the first and second reception modes according to resources allocated to D2D communication.

In an example embodiment of the present invention below, assuming that D2D communication is performed in a 3GPP Long Term Evolution (LTE) system, an example in which the first transmission mode is SC-FDMA, the second transmission mode is OFDMA, the first reception mode is OFDMA, and the second reception mode is SC-FDMA will be described. However, the present invention is not limited to the example embodiment. When D2D communication is not performed in a 3GPP LTE communication environment, and different transmission techniques are used in an uplink and a downlink, the first and second transmission modes and the first and second reception modes may be changed with other transmission techniques.

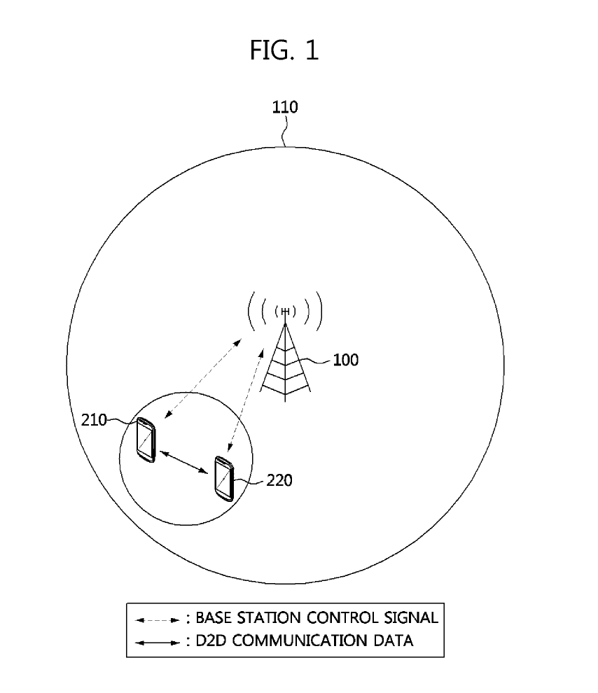

FIG. 1 is a conceptual diagram of a network environment to which a D2D communication control method according to an example embodiment of the present invention is applied.

Referring to FIG. 1, a D2D communication control method according to an example embodiment of the present invention may be applied to a case where terminals 210 and 220 adjacent to each other in a predetermined cell 110 perform D2D communication not via a control apparatus 100 that manages the predetermined cell 110.

The control apparatus 100 may be, for example, a base station managing a macro cell, and performs resource allocation for D2D communication and control for D2D communication. For convenience, assuming that the control apparatus 100 is a base station, a D2D communication control method according to example embodiments of the present invention will be described below.

The base station 100 allocates uplink resources or downlink resources for D2D communication, sets an MCS and transmission power of a terminal, and then transmits the set resource allocation information and control information to the terminals 210 and 220 that will perform D2D communication using D2D-DCI.

The terminals 210 and 220 that will perform D2D communication perform D2D communication on the basis of the D2D-DCI transmitted from the base station 100 through a downlink. Here, according to the received D2D-DCI, each of the D2D terminals 210 and 220 may determine whether the terminal itself is a transmission terminal or a reception terminal, and determine whether the allocated resources are uplink resources or downlink resources.

On the basis of the resource allocation information, the MCS information and the transmission power information included in the D2D-DCI, the transmission terminal 210 between the D2D communication terminals 210 and 220 switches a transmission mode of a transmitter prepared therein in case of necessity, applies the MCS to the allocated resources, and then adjusts transmission power, thereby transmitting data. Here, when the allocated resources are downlink resources, the transmission terminal 210 may switch a transmission mode from SC-FDMA to OFDMA.

Also, on the basis of the control information included in the D2D-DCI, the reception terminal 220 between the D2D communication terminals 210 and 220 switches a reception mode of a receiver prepared therein in case of necessity, thereby receiving the data. Here, when the allocated resources are uplink resources, the reception terminal 220 may switch a reception mode from OFDMA to SC-FDMA.

A centralized D2D communication system in which a base station allocates resources required for D2D communication and controls D2D communication as described above, is a model that is most appropriate for providing initial D2D communication service. The centralized D2D communication system can minimize influence exerted on an existing network, reduce the load of self-control of a D2D terminal, and facilitate interference control due to management of D2D communication resources and resources for general cellular communication by a base station.

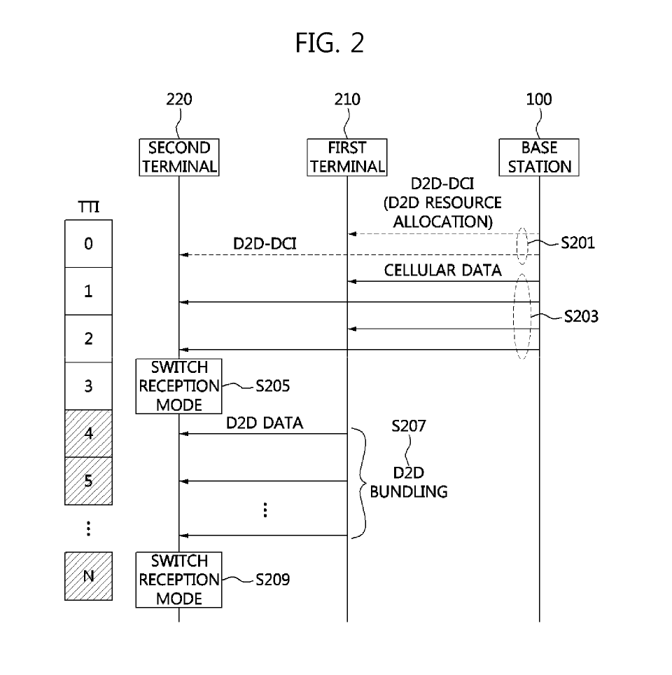

FIG. 2 is a flowchart illustrating a D2D communication control method according to an example embodiment of the present invention.

In FIG. 2, an example of a resource allocation and control procedure for D2D communication is illustrated in which a first terminal 210 and a second terminal 220 perform D2D communication using uplink resources when the first terminal 210 is a transmission terminal, and the second terminal 220 is a reception terminal.

Referring to FIG. 2, first, a base station 100 allocates uplink resources as resources to be used in D2D communication, determines an MCS, transmission power, a transmission terminal (i.e., the first terminal), and a reception terminal (i.e., the second terminal) to be applied to D2D communication, and then transmits such information to the first terminal 210 and the second terminal 220 using D2D-DCI (S201).

Here, when determining the resources to be used in D2D communication, the base station 100 dynamically allocates the resources in consideration of a condition of resources currently used in cellular communication, an interference situation between D2D communication and cellular communication, etc., thereby maximizing resource use efficiency and minimizing interference.

The first and second terminals 210 and 220 check the resource allocation information and the D2D communication control information from the D2D-DCI received from the base station 100, and then perform a process corresponding to the resource allocation information and the D2D communication control information. In the example of FIG. 2, the first and second terminals 210 and 220 receive D2D-DCI at transmission time interval (TTI) 0, that is, a first TTI, and four TTIs thereafter (i.e., at TTI 4), the first terminal 210 transmits data to the second terminal 220.

Here, the first and second terminal 210 and 220 may receive cellular communication data at second and third TTIs (i.e., TTI 1 and TTI 2) according to scheduling of the base station 100 (S203).

The second terminal 220 checks that the second terminal 220 itself is a reception terminal on the basis of the information included in the received D2D-DCI. Also, the second terminal 220 checks that the resources allocated for D2D communication are uplink resources on the basis of the information included in the D2D-DCI, and switches a reception mode of its receiver from OFDMA to SC-FDMA before a point in time when the first terminal 210 transmits data (i.e., TTI 4) (S205). In the example of FIG. 2, the first terminal 210 transmits data at a fifth TTI (i.e., TTI 4), and thus the second terminal 220 switches the reception mode at a fourth TTI (i.e., TTI 3), that is, before the first terminal 210 transmits data.

The first terminal 210 checks that the first terminal 210 itself is a transmission terminal from the D2D-DCI received from the base station 100, checks the data transmission time point on the basis of the control information included in the D2D-DCI, and then transmits data to the second terminal 220 at the transmission time using the allocated resources.

Here, the first terminal 210 processes the transmission data by applying the MCS to the uplink resources allocated using the D2D-DCI, and then transmits the data to the second terminal 220.

D2D communication between the first terminal 210 and the second terminal 220 may be performed during a D2D bundling time designated in the D2D-DCI (S207). Here, the D2D bundling time may denote a time range to which the D2D-DCI determined by the base station 100 is applied. The base station 100 may determine the D2D bundling time in consideration of moving speeds, proximity, etc. of the terminals that will perform D2D communication, thereby reducing the load of frequent scheduling.

When the D2D bundling time expires, the first terminal 210 stops data transmission to the second terminal 220, and the second terminal 220 switches the reception mode of the receiver from SC-FDMA to OFDMA, that is, cellular communication data reception mode (S209).

For convenience, FIG. 2 illustrates the example in which the first terminal 210 is a transmission terminal, and the second terminal 220 is a reception terminal. However, even when the second terminal 220 is a transmission terminal, and the first terminal 210 is a reception terminal, the same D2D communication control method as illustrated in FIG. 2 can be used.

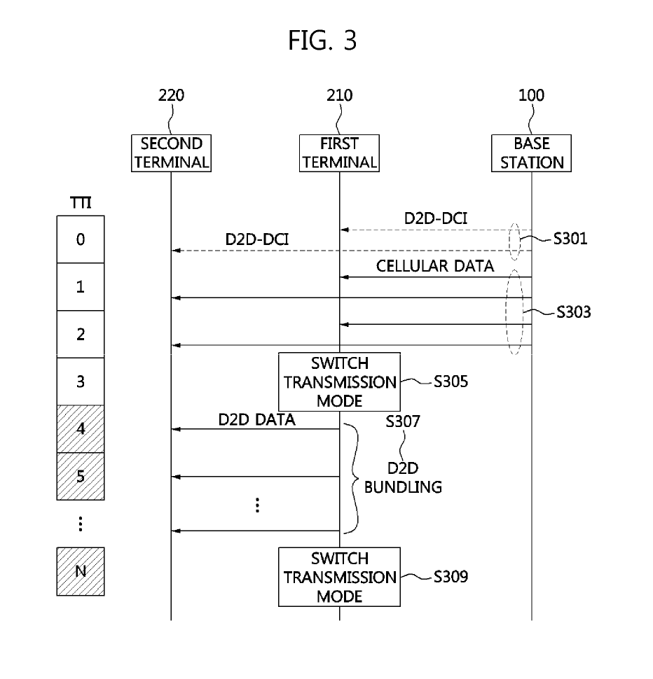

FIG. 3 is a flowchart illustrating a D2D communication control method according to another example embodiment of the present invention.

In FIG. 3, an example of a resource allocation and control procedure for D2D communication is illustrated in which a first terminal 210 and a second terminal 220 perform D2D communication using downlink resources when the first terminal 210 is a transmission terminal, and the second terminal 220 is a reception terminal.

Referring to FIG. 3, first, a base station 100 allocates downlink resources as resources to be used in D2D communication, determines an MCS, transmission power, a transmission terminal (i.e., the first terminal), and a reception terminal (i.e., the second terminal) to be applied to D2D communication, and then transmits such information to the first terminal 210 and the second terminal 220 using D2D-DCI (S301).

The first and second terminals 210 and 220 check the resource allocation information and the D2D communication control information from the D2D-DCI received from the base station 100, and then perform a process corresponding to the resource allocation information and the D2D communication control information. In the example of FIG. 3, the first and second terminals 210 and 220 receive D2D-DCI at a first TTI (i.e., TTI 0), and four TTIs thereafter (i.e., at TTI 4), the first terminal 210 transmits data to the second terminal 220 using the downlink resources.

The first and second terminal 210 and 220 may receive cellular communication data at second and third TTIs (i.e., TTI 1 and TTI 2) according to scheduling of the base station 100 (S303).

The first terminal 210 checks that the first terminal 210 itself is a transmission terminal on the basis of the information included in the D2D-DCI received from the base station. Also, the first terminal 210 checks that the resources allocated for D2D communication are downlink resources on the basis of the information included in the D2D-DCI, and switches a transmission mode of its transmitter from SC-FDMA to OFDMA before a point in time of data transmission (i.e., TTI 4) (S305). In the example of FIG. 3, the first terminal 210 transmits data at a fifth TTI (i.e., TTI 4), and thus the first terminal 210 switches the transmission mode at a fourth TTI (i.e., TTI 3), that is, before the first terminal 210 transmits data.

Also, the first terminal 210 processes the transmission data by applying the MCS to the downlink resources allocated using the D2D-DCI, and then transmits the data to the second terminal 220.

The second terminal 220 checks that the second terminal 220 itself is a reception terminal from the D2D-DCI received from the base station 100, checks a point in time of data reception on the basis of the control information included in the D2D-DCI, and then receives the transmitted data using the downlink resources at the reception time.

D2D communication between the first terminal 210 and the second terminal 220 may be performed during a D2D bundling time designated in the D2D-DCI (S307).

When the D2D bundling time expires, the first terminal 210 stops data transmission to the second terminal 220, and the first terminal 210 switches the transmission mode of the receiver from OFDMA to SC-FDMA, that is, cellular communication data transmission mode (S309).

For convenience, FIG. 3 illustrates the example in which the first terminal 210 is a transmission terminal, and the second terminal 220 is a reception terminal. However, even when the second terminal 220 is a transmission terminal, and the first terminal 210 is a reception terminal, the same D2D communication control method as illustrated in FIG. 3 can be used.

In a 3GPP-based cellular mobile communication system, a cellular terminal is addressed using a radio network temporary identifier (RNTI) that is an identifier in a cell. Thus, even when the cellular terminal receives DCI, the terminal acquires DCI transmitted to the terminal itself using the RNTI.

In a D2D communication control method according to example embodiments of the present invention, D2D terminals that will perform D2D communication are specified by allocating D2D-RNTIs to D2D terminals so that the terminals can receive D2D-DCI.

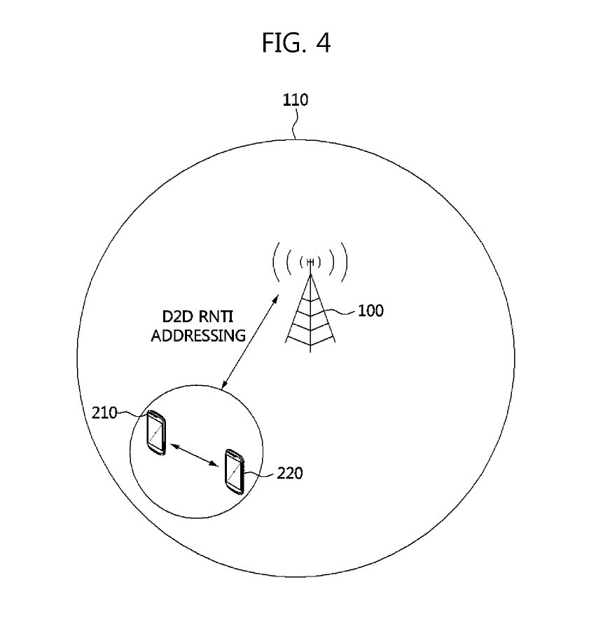

FIG. 4 is a conceptual diagram illustrating D2D-RNTIs allocated to terminals that will perform D2D communication in a D2D communication control method according to an example embodiment of the present invention.

As illustrated in FIG. 4, in a D2D communication control method according to an example embodiment of the present invention, a base station 100 allocates D2D-RNTIs to terminals 210 and 220 that will perform D2D communication, and the terminals 210 and 220 allocated the D2D-RNTIs by the base station 100 receive D2D-DCI using the allocated D2D-RNTIs.

In a group-type D2D service, a representative-type D2D service, etc. among various business models of D2D communication, a D2D-RNTI may also be used for managing all D2D terminals belonging to the same D2D communication group. For example, in a predetermined D2D service type, the same D2D-RNTI may be allocated to all D2D terminals belonging to the same D2D communication group.

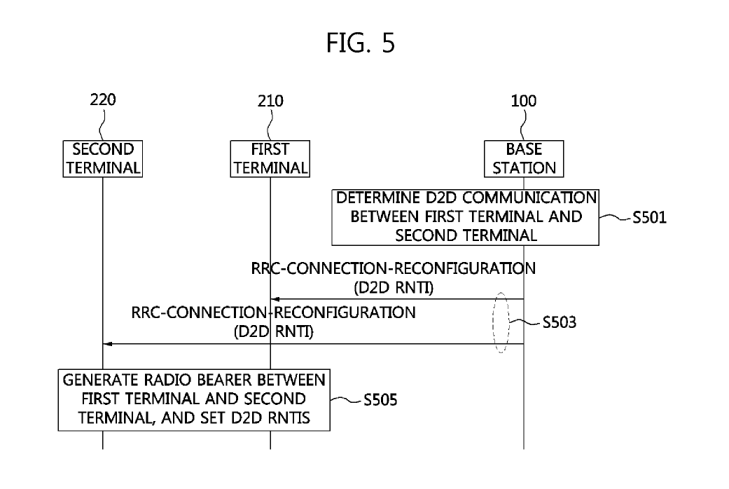

FIG. 5 is a flowchart illustrating a procedure of allocating D2D-RNTIs in a D2D communication control method according to an example embodiment of the present invention.

Referring to FIG. 5, first, a base station 100 determines D2D communication between a first terminal 210 and a second terminal 220 (S501), includes D2D-RNTIs in a radio resource control (RRC) connection reconfiguration message, and transmits the RRC connection reconfiguration message to the first terminal 210 and the second terminal 220 (S503).

The first terminal 210 and the second terminal 220 receive the RRC connection reconfiguration message transmitted from the base station 100, generate a radio bearer between them, and set the D2D-RNTIs (S505).

In the above-described D2D communication control method, a control apparatus allocates uplink or downlink resources in consideration of use of cellular resources, interference, etc., determines an MCS, transmission power, etc., and then transmits D2D-DCI including resource allocation information and control information to D2D terminals, and the D2D terminals switch a transmission mode or a reception mode at the corresponding point in time on the basis of the received D2D DCI, and then perform D2D communication during a D2D bundling time included in the D2D-DCI. Also, to control D2D communication as mentioned above, D2D terminals included in a cell are addressed using D2D-RNTIs.

Consequently, cellular resources can be reused, and use efficiency of radio resources can be improved. In addition, a control apparatus performs control for D2D communication, so that terminals performing D2D communication can reduce the load of self-control. Furthermore, since direct communication is performed between terminals adjacent to each other via no base station, it is possible to reduce delay time and power consumption.

While example embodiments of the present invention and their advantages have been described in detail, it should be understood that various changes, substitutions and alterations may be made herein without departing from the scope of the invention.

What is claimed is:

1. A device-to-device (D2D) communication control method performed in a control apparatus, comprising:
allocating resources for D2D communication; and
including information about the allocated resources in D2D-downlink control information (DCI), and transmitting the D2D-DCI to terminals that will perform D2D communication.

2. The D2D communication control method of claim 1, wherein allocating the resources for D2D communication includes allocating one kind of resources among uplink and downlink resources of a cellular mobile communication system, and setting information for distinguishing a transmission terminal and a reception terminal between the terminals that will perform D2D communication, and at least one piece of control information among transmission power, a modulation and coding scheme (MCS), and bundling time information indicating a time for performing D2D communication.

3. The D2D communication control method of claim 1, wherein allocating the resources for D2D communication includes allocating, at the control apparatus, the resources for D2D communication in consideration of a condition of resources used in cellular communication, and interference between terminals performing cellular communication and the terminals that will perform D2D communication.

4. The D2D communication control method of claim 1, further comprising:
allocating D2D-radio network temporary identifiers (RNTIs) for addressing the D2D terminals that will perform D2D communication; and
including the D2D-RNTIs in a radio resource control (RRC) connection reconfiguration message, and transmitting the RRC connection reconfiguration message to the D2D terminals.

5. The D2D communication control method of claim 4, wherein allocating the D2D-RNTIs includes, when the terminals belong to the same communication group in a predetermined D2D communication service type, allocating the same D2D-RNTI to the terminals.

6. A device-to-device (D2D) communication control method, comprising:
acquiring information about resources allocated for D2D communication on the basis of received downlink control information (DCI);
when the allocated resources are uplink resources, and it is not possible to receive transmitted data through uplink resources in a current reception mode, switching the reception mode from a first reception mode to a second reception mode;
receiving D2D communication data in the second reception mode; and
when reception of the D2D communication data is finished, switching the reception mode from the second reception mode to the first reception mode.

7. The D2D communication control method of claim 6, wherein switching the reception mode from the first reception mode to the second reception mode is performed in a transmission time interval (TTI) ahead of a TTI in which reception of the D2D communication data is started on the basis of the DCI.

8. The D2D communication control method of claim 6, wherein receiving the D2D communication data in the second reception mode includes receiving the data during a D2D bundling time included in the DCI, and
switching the reception mode from the second reception mode to the first reception mode is performed after the D2D bundling time expires.

9. A device-to-device (D2D) communication control method, comprising:
acquiring information about resources allocated for D2D communication on the basis of received downlink control information (DCI);
when the allocated resources are downlink resources, and it is not possible to transmit data through downlink resources in a current transmission mode, switching the transmission mode from a first transmission mode to a second transmission mode;
transmitting D2D communication data in the second transmission mode; and
when transmission of the D2D communication data is finished, switching the transmission mode from the second transmission mode to the first transmission mode.

10. The D2D communication control method of claim 9, wherein switching the transmission mode from the first transmission mode to the second transmission mode is performed in a transmission time interval (TTI) ahead of a TTI in which transmission of the D2D communication is started on the basis of the DCI.

11. The D2D communication control method of claim 9, wherein transmitting the data in the second transmission mode includes transmitting the data during a D2D bundling time included in the DCI, and
switching the transmission mode from the second transmission mode to the first transmission mode is performed after the D2D bundling time expires.

12. A device-to-device (D2D) communication control method, comprising:
allocating, at a control apparatus, resources for D2D communication;
including, at the control apparatus, allocation information about the allocated resources in D2D-downlink control information (DCI), and transmitting the D2D-DCI to D2D terminals that will perform D2D communication;
acquiring, at each of the D2D terminals, the resource allocation information on the basis of the received DCI;
switching, at each of the D2D terminals, a transmission or reception mode on the basis of the resource allocation information;
performing, at the D2D terminals, D2D communication; and
switching, at each of the D2D terminals, a post-switching transmission or reception mode back to the original mode after D2D communication is finished.

13. The D2D communication control method of claim 12, wherein switching, at each of the D2D terminals, a transmission or reception mode on the basis of the resource allocation information includes switching, at a transmission terminal between the D2D terminals, the transmission mode when the transmission terminal cannot transmit data using the allocated resources, or switching, at a reception terminal between the D2D terminals, the reception mode when the reception terminal cannot receive data using the allocated resources.

14. The D2D communication control method of claim 12, wherein performing, at the D2D terminals, D2D communication includes performing D2D communication during a D2D bundling time included in the DCI.
